(19) United States
(12) Patent Application Publication
(10) Pub. No.: US 2017/0048341 A1
(43) Pub. Date: Feb. 16, 2017

(54) APPLICATION USAGE MONITORING AND PRESENTATION

(71) Applicant: Amazon Technologies, Inc., Reno, NV (US)

(72) Inventors: Kenneth M. Karakotsios, San Jose, CA (US); Bradley Bozarth, Sunnyvale, CA (US)

(21) Appl. No.: 15/271,217

(22) Filed: Sep. 20, 2016

Related U.S. Application Data
(63) Continuation of application No. 12/950,896, filed on Nov. 19, 2010.

(51) Int. Cl. H04L 29/08

(52) U.S. Cl. CPC H04L 67/22; H04L 67/02

(57) ABSTRACT

A computing device can continuously monitor application usage. The data monitored can include an amount (absolute or relative) of processing, memory, storage, network, and/or power resources used by each application of the computing device over time. The computing device can simultaneously display the application usage data for multiple applications over a specified period of time. A user may interact with how the computing device presents the application usage data, such as by scrolling a time axis to review application usage data over a different period of time, scrolling an application axis to review application usage data of one or more different applications over the specified period of time, zoom in/zoom out to view the application usage data at a more/less granular unit of time, tilt the computing device to lengthen or shorten the time axis (and shorten/lengthen the application axis), or sort the application usage data, among other possibilities.

### CROSS-REFERENCES TO RELATED APPLICATIONS

This application is a continuation of U.S. application Ser. No. 12/950,896, filed on Nov. 19, 2010, the content of which is incorporated herein by reference.

### BACKGROUND

Users are increasingly relying upon various electronic and computing devices to store, track, and update various types of information and handle various types of tasks. For example, many users rely upon computing devices to store contact information, user schedules, task lists, and other such information. Further, users also store various types of files and addresses such as media files, email messages, Web site links, and other types of information. One problem with accessing such information is that the information is typically stored separately, in what are referred to as “data silos,” where information used for one application is stored separately from information for another application. Information in these silos is not directly linked, may not be externally accessible, and may be tough to correlate. For example, GPS data might track where a user is at any given time, and browse history might track which Web sites a user visits at any given time, but there is no direct way (without aggregating and processing the data) to determine which Web sites were viewed at which locations.

Further, the approaches for searching within a data silo are also limited. For example, a browser history might store a list of Web sites that the user visited, which can be sorted by conventional dimensions such as name and time. If a user wants to determine the address of a site that the user viewed when the user was in a particular restaurant some time last month using conventional approaches, the user typically would have to open the browse history and scroll through many days of data in order to attempt to find the relevant site. Thus, data is not organized or presented in a way that is intuitive for many users, or follows patterns matching the ways in which users typically think.

### BRIEF DESCRIPTION OF THE DRAWINGS

Various embodiments in accordance with the present disclosure will be described with reference to the drawings, in which:

FIG. 1 illustrates front and back views of an example user device that can be utilized in accordance with various embodiments;

FIG. 2 illustrates example components of a user device that can be utilized in accordance with various embodiments;

FIGS. 3(a) and 3(b) illustrate an example interface showing locations of a user along with actions or information associated with the user and location at the respective times that can be used in accordance with at least one embodiment;

FIGS. 4(a) and 4(b) illustrate an example interface enabling a user to scroll through various dimensions of data in accordance with at least one embodiment;

FIGS. 5(a) and 5(b) illustrate an example interface for viewing information along a selected dimension that can be used in accordance with at least one embodiment;

FIGS. 6(a)-6(d) illustrate an example interface for locating data across multiple dimensions that can be used in accordance with at least one embodiment;

FIG. 7 illustrates an example time-based interface that can be utilized to locate information across dimensions in accordance with at least one embodiment;

FIG. 8 illustrates an example social networking interface that can be used to locate information across dimensions in accordance with at least one embodiment;

FIG. 9 illustrates an example social graph that can be used to locate information across dimensions in accordance with at least one embodiment;

FIGS. 10(a)-10(c) illustrate portions of an example process for capturing, associating, and utilizing data across multiple dimensions can be utilized in accordance with various embodiments;

FIGS. 11(a)-11(e) illustrate example motions of a portable device that can be used to provide input to various interfaces described herein; and

FIG. 12 illustrates an environment in which various embodiments can be implemented.

### DETAILED DESCRIPTION

Systems and methods in accordance with various embodiments of the present disclosure overcome one or more of the above-referenced and other deficiencies in conventional approaches to obtaining and managing data and other types of information. In particular, various embodiments provide the ability to capture and associate data across multiple dimensions, where a dimension generally is a data type, category, or element characterizing a region or portion of a data set according to a meaningful separation (e.g., data, group, region, etc.). Dimensions are typically useful for functions such as grouping, sorting, and filtering of a data set. Such approaches can provide for an extended associative memory that enables a user (or application) to locate information using associations that are natural and/or intuitive to that user. Various embodiments also enable an application, user, module, service, or other such entity or component to access, view, search, and otherwise interact with the data across any of the captured and associated dimensions. For example, a user can utilize various different views and combinations of dimensions to locate information that is of interest to the user, in a way that is more intuitive for the user and more closely matches the way the user thinks than conventional list-based approaches. Further, the paths and views used to find data, files, or other information of interest to different users can be dynamically adjusted for each user without any configuration or training process. Further, applications are not limited by data in application-specific silos, but can provide enhanced functionality by having the ability to leverage other types of data that are not readily accessible in conventional systems.

In various embodiments, one or more computing or electronic devices can be configured to capture various dimensions of data for a user (or other group or entity, etc.). The dimensions for which data is collected can vary based upon a number of factors, such as user preference, available applications, the type of device, available uses of the device, settings, configurations, permissions, authorizations, and other such factors. A device can associate data across a number of different dimensions using any appropriate mapping or correlation approach, such as through the use of tags or meta data. The data can be correlated before storing, such as by associating data for (1) a particular caller at (2) a certain time to (3) a certain device before storing that data, or after storing, such as by tagging each piece of data and correlating the dimensions such that for subsequent analysis those pieces of data can be aggregated and/or associated. Various other approaches can be utilized as well within the scope of the various embodiments.

Various embodiments also provide interfaces that take advantage of the multi-dimensional associations. For example, a user can select to view a “context” or other state, collection, or grouping of data. The selected context can determine information such as the dimensions of data that are displayed, how those dimensions are displayed, and how the data for the dimensions is sorted. When displayed, the user can have the ability to scroll, zoom, or otherwise navigate about the interface to find a dimension of interest, and potentially a value or range of values of that data. The user can also combine, join, or select additional dimensions in order to assist in locating data. For example, the user can select to view all data for a first dimension that is associated with a second dimension, and so on. Such an approach enables a user to utilize different dimensions as nodes, branches, or portions of a path to get to the information of interest, where that path can be different for each user as may be based at least in part upon how that user thinks about, processes, and/or manages data. Similar approaches can enable applications or other entities to locate and/or utilize data through various dimension associations.

Various other functions and advantages are described and suggested below as may be provided in accordance with the various embodiments.

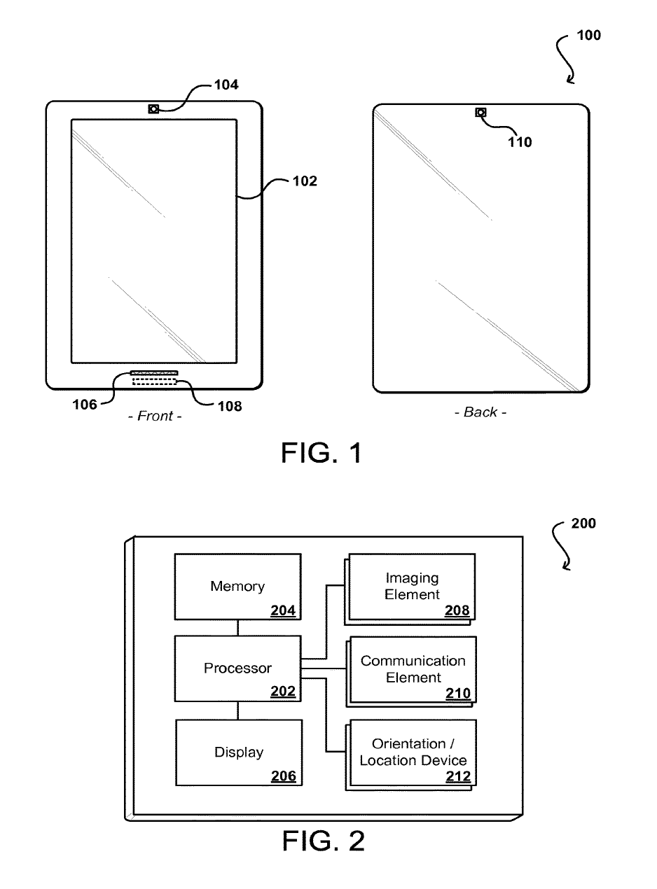

FIG. 1 illustrates front and back views, respectively, of an example electronic user device 100 that can be used in accordance with various embodiments. Although a portable computing device (e.g., an electronic book reader or tablet computer) is shown, it should be understood that any electronic device capable of receiving, determining, and/or processing input can be used in accordance with various embodiments discussed herein, where the devices can include, for example, desktop computers, notebook computers, personal data assistants, smart phones, video gaming consoles, television set top boxes, and portable media players. In this example, the computing device 100 has a display screen 102 on the front side, which under normal operation will display information to a user facing the display screen (e.g., on the same side of the computing device as the display screen). The computing device in this example includes a front image capture element 104 and a back image capture element 110 positioned on the device such that, with sufficient wide angle lenses or other such optics, the computing device 100 is able to capture image information in substantially any direction about the computing device. In some embodiments, the computing device might only contain one imaging element, and in other embodiments the computing device might contain several imaging elements. Each image capture element may be, for example, a camera, a charge-coupled device (CCD), a motion detection sensor, or an infrared sensor, among many other possibilities. If there are multiple image capture elements on the computing device, the image capture elements may be of different types. In some embodiments, at least one imaging element can include at least one wide-angle optical element, such as a fish eye lens, that enables the camera to capture images over a wide range of angles, such as 180 degrees or more. Further, each image capture element can comprise a digital still camera, configured to capture subsequent frames in rapid succession, or a video camera able to capture streaming video.

The example computing device 100 also includes a microphone 106 or other audio capture device capable of capturing audio data, such as words or commands spoken by a user of the device. In this example, a microphone 106 is placed on the same side of the device as the display screen 102, such that the microphone will typically be better able to capture words spoken by a user of the device. In at least some embodiments, the microphone can be a directional microphone that captures sound information from substantially directly in front of the device, and picks up only a limited amount of sound from other directions, which can help to better capture words spoken by a primary user of the device. It should be understood, however, that a microphone might be located on any appropriate surface of any region, face, or edge of the device in different embodiments, and that multiple microphones can be used for audio recording and filtering purposes, etc.

The example computing device 100 also includes at least one position and/or orientation determining element 108. Such an element can include, for example, an accelerometer or gyroscope operable to detect an orientation and/or change in orientation of the computing device, as well as small movements of the device. An orientation determining element also can include an electronic or digital compass, which can indicate a direction (e.g., north or south) in which the device is determined to be pointing (e.g., with respect to a primary axis or other such aspect). A location determining element also can include or comprise a global positioning system (GPS) or similar positioning element operable to determine relative coordinates for a position of the computing device, as well as information about relatively large movements of the device. Various embodiments can include one or more such elements in any appropriate combination. As should be understood, the algorithms or mechanisms used for determining relative position, orientation, and/or movement can depend at least in part upon the selection of elements available to the device.

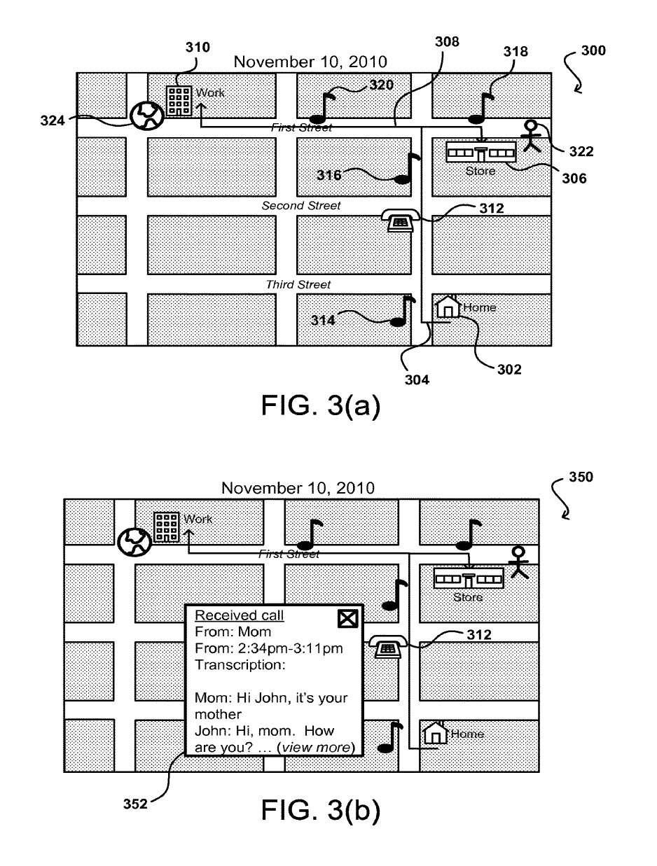

FIG. 2 illustrates a logical arrangement of a set of general components of an example computing device 200 such as the device 100 described with respect to FIG. 1. In this example, the device includes a processor 202 for executing instructions that can be stored in a memory device or element 204. As would be apparent to one of ordinary skill in the art, the device can include many types of memory, data storage, or non-transitory computer-readable storage media, such as a first data storage for program instructions for execution by the processor 202, a separate storage for images or data, a removable memory for sharing information with other devices, etc. The device typically will include some type of display element 206, such as a touch screen or liquid crystal display (LCD), although devices such as portable media players might convey information via other means, such as through audio speakers. As discussed, the device in many embodiments will include at least one image capture element 208 such as a camera or infrared sensor that is able to image projected images or other objects in the vicinity of the device. Methods for capturing images or video using a camera element with a computing device are well known in the art and will not be discussed herein in detail. It should be understood that image capture can be performed using a single image, multiple images, periodic imaging, continuous image capturing, image streaming, etc. Further, a device can include the ability to start and/or stop image capture, such as when receiving a command from a user, application, or other device.

In some embodiments, the computing device 200 of FIG. 2 can include one or more communication elements (not shown), such as a Wi-Fi, Bluetooth, RF, wired, or wireless communication system. The device in many embodiments can communicate with a network, such as the Internet, and may be able to communicate with other such devices. In some embodiments the device can include at least one additional input device able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device.

The device 200 also can include at least one orientation, movement, and/or location determination mechanism 212. As discussed, such a mechanism can include an accelerometer or gyroscope operable to detect an orientation and/or change in orientation, or an electronic or digital compass, which can indicate a direction in which the device is determined to be facing. The mechanism(s) also (or alternatively) can include or comprise a global positioning system (GPS) or similar positioning element operable to determine relative coordinates for a position of the computing device, as well as information about relatively large movements of the device. The device can include other elements as well, such as may enable location determinations through triangulation or another such approach. These mechanisms can communicate with the processor 202, whereby the device can perform any of a number of actions described or suggested herein.

As an example, a computing device such as that described with respect to FIG. 1 can capture and/or track various information for a user over time. This information can include any appropriate information, such as location, actions (e.g., sending a message or creating a document), user behavior (e.g., how often a user performs a task, the amount of time a user spends on a task, the ways in which a user navigates through an interface, etc.), user preferences (e.g., how a user likes to receive information), open applications, submitted requests, received calls, and the like. As discussed above, the information can be stored in such a way that the information is linked or otherwise associated whereby a user can access the information using any appropriate dimension or group of dimensions.

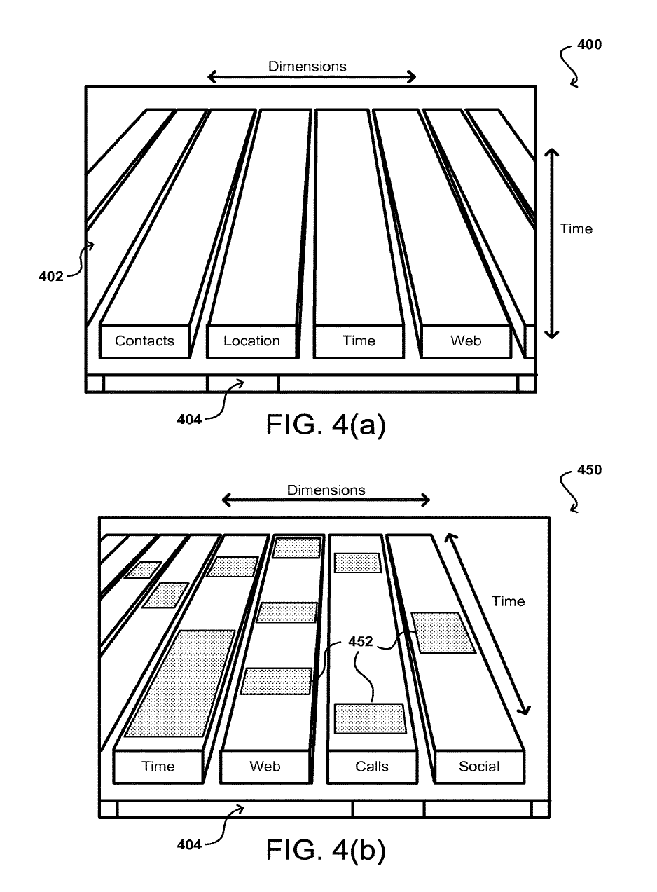

For example, FIG. 3(a) illustrates an example graphical user interface (GUI) 300 that can be used to access information across multiple dimensions in accordance with at least one embodiment. In this example, a computing device can track a location of a user over time using information such as GPS data, accelerometer data, electronic compass data, etc. The data can be captured by the computing device, or determined by an outside system or service (e.g., a cellular provider) and obtained by the device (or another outside system or service, etc.). In this example, the device captured the locations of the user on a particular date, here Nov. 10, 2010. The device can be configured to capture location information at any appropriate interval, such as every few seconds, every time the user moves at least a threshold distance, etc. The device also can be configured to capture other types of information at those times as well, and associate that other information with the position information. For example, in FIG. 3(a) the user is detected to turn out of the user's home 302, the position of which can be determined through user entry, address information, behavior-based inferences, or any other appropriate process. As the user is leaving the user's house, the device might play a song from the user's media library. The time and location can be associated with information for that song. Thus, if a user wants to locate information about that song, and the user remembers that the user heard that song just after leaving home on that day, the user can pull up an interface such as the one illustrated in FIG. 3(a) and move to a position near the user's home. As can be seen, there is a graphical icon 314 representing the position at which that song was played by the user device. Thus, the user can quickly find the song using the associated information the user has, without having to scroll through songs on a playlist, etc. As discussed elsewhere herein, the user then can access any of a number of different types of information about that song, or any other type of media or information. For example, the user can access not only information about the song itself, but also contextual information such as when the user accessed the song, where the user was when accessing, how often the song was accessed, whether the user typically skips over that song, playlists to which the user has added that song, and various other types of information.

Similarly, the user might receive a call on a mobile device while the user is moving. Another icon 312 can be displayed that illustrates approximately where the user was when the user received the call. In the example, the user can utilize the captured and associated information in a number of different ways. For example, the user might not remember when the user received the call but might remember where, so the user can find information based on the call based on where the call was received. Similarly, the user might only remember receiving the call on the way to work 310, so the user might be able to find the call based on time and/or the route the user took. In another example, the user might not remember the location of a business such as a restaurant, but might remember that the user passed the restaurant when the user was on that call. By locating the position where the user received the call, the user can also determine the approximate location of the restaurant.

Various other information is illustrated on the interface 300 that was captured by the device on the Nov. 10, 2010. For example, different songs that the user listened to are represented by a plurality of icons 316, 318, 320 positioned at the approximate locations where the user listened to those songs. The route 308 the user took is also captured and can be displayed. An icon 306 representing a store that the user visited during that time is illustrated, along with an icon 322 illustrating a person whom the user met at the store. The identity of the person the user met can be determined by the device using any appropriate method, such as voice or image recognition. In other embodiments, the user device can communicate with a device of that person and log the interaction. Another icon 324 can represent one or more Web sites that the user visited while at work. Various other types of information can be captured and associated with time and/or location as well, as may be advantageously displayed on such an interface.

Such an interface allows for relatively complex determinations that would be difficult to determine using conventional approaches. For example, the user might remember taking an important call right before meeting someone at the store. If the user does not remember the date or time, the user might search the location data for occurrences when the user met the person or went to the store, then look at call data taken near that location or around that time. Using conventional approaches, a user would likely have to narrow down a set of times when the user might have received the call, and then search through call logs to attempt to find the call of record. In some embodiments, the user can filter the data on the interface to include times around when the user went to that store and/or met that user, and can use that information to quickly find the call of interest.

FIG. 3(b) illustrates an example feature that can be used with such an interface to assist in quickly locating the information of interest. In this example, the user can select (e.g., click or mouse-over) a displayed icon 312, and receive a pop-up, modal window, or other such display including basic information associated with that icon, here including basic information about the call received at that location at that time. The information can include any appropriate information, such as the time and duration of the call, an identity of the other party, etc. In some embodiments, a user can have the option of capturing audio information for the call (either automatically, or upon the user selecting a “listen” or other such element). If the device at least temporarily records the audio, the device can store the audio for subsequent playback and/or transcribe the audio such that the user can view the transcription upon request. In this example, a preview window 352 provides a portion of the transcription along with basic information. In some embodiments, the user can scroll through the transcription in this window to determine if this is the call of interest and/or obtain information from the transcription. In other embodiments, the user can select the call or “zoom in” on the information to obtain more detail, go to a dedicated page, or perform another such action. In some embodiments, the user can use information from the call (such as the identity of the caller or contents of the transcription) to view information along another dimension. For example, in FIG. 3(b) the identity of the caller is “Mom.” By selecting the dimension “Mom,” for example, the user might be able to view other calls from that caller, view address or contact information about that caller, etc. A variety of other information can quickly be obtained that is associated with an aspect of that call.

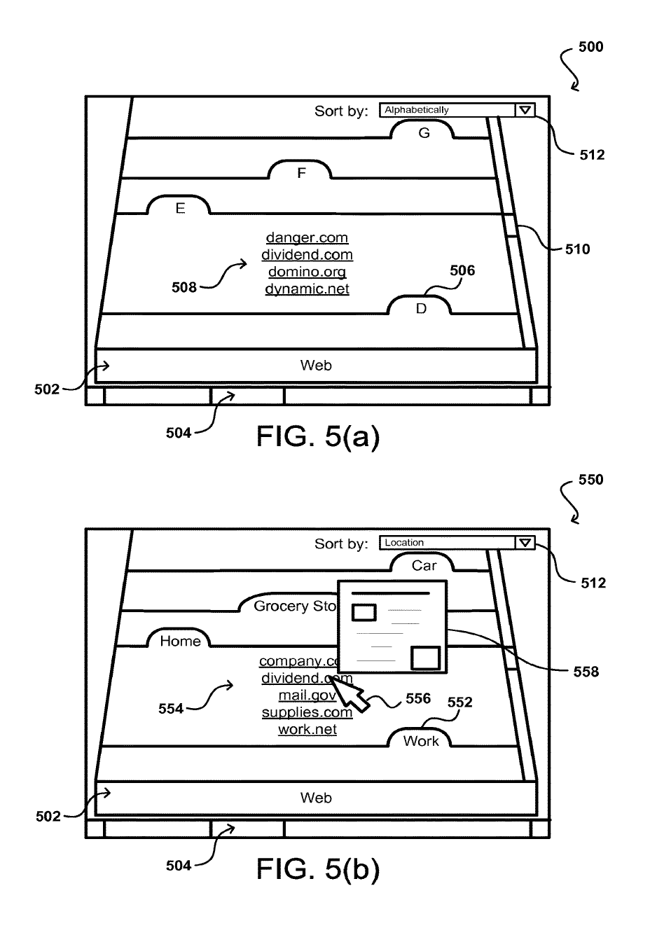

As discussed, information can be captured for many different dimensions. Various data logging schemes can be used that enable dimensions to be handled separately as needed, while providing for the necessary associations. In conventional approaches this information might be segregated into several separate data silos. Approaches in accordance with various embodiments enable the data to be stored in such a way that the data can be accessed, cross-referenced, aggregated, processed, or otherwise utilized together for any of a number of different reasons. FIG. 4(a) illustrates an example interface 400 wherein a number of dimensions 402 are presented as three-dimensional blocks, axes, or other such representations, which enables a user to quickly navigate to at least one dimension of interest. For example, a user can select a dimension by clicking on, touching, or otherwise interacting with one of the dimension representations 402. If more dimensions are available than can be shown on the screen at the current time, resolution, or zoom, etc., then the user can use a scroll bar 404 or other such element to navigate to different dimensions. In other embodiments, as discussed elsewhere herein, the user can tilt or shift a mobile device in an appropriate direction to cause the displayed selection of dimensions to change, similar to might occur due to a scrolling or dragging action. Other navigational approaches can be used as well as would be apparent to one of ordinary skill in the art in light of the teachings and suggestions contained herein. As can be seen in the interface display 450 of FIG. 4(b), performing such an action enables a different selection of dimensions to be displayed. Also, FIG. 4(b) illustrates how icons 452 might be displayed for data points along each dimension according to the current sorting dimension. In this example, the relative size of the icon is indicative of the amount of data for that dimension. For example, if the sorting dimension is time, then the length of each icon can be representative of a length of time corresponding to each data point. If the sorting order is alphabetical, for example, the length of each icon can be representative of the number of entries for a given letter (with the icon representing the letter). Various other dimensional aspects can be used to provide information via the icons as well, such as colors, images, or animations representing types of dimensional information, etc.

The information for each dimension (represented by an axis, block, plane, etc.) can be sorted by any appropriate dimension or other such aspect. In this example, the dimensions are sorted by time, such that the display can be referred to as a “timeline interface.” An advantage of such a timeline interface is that a user can compare information across various dimensions for a single point in time, or range of times. For example, a user can zoom the interface to show a particular range of time, or as discussed elsewhere herein can select a certain time from the time axis to obtain a “cross-section” across the various dimensions at the selected time. Such an approach enables the user to quickly be able to view and/or associatively access information for a point in time across multiple dimensions in a single interface. For example, the user might be able to select a specific time, such as 9:30 a.m. on last Thursday. The user might be able to obtain a view across dimensions that indicates that the user was in a room at a certain location with a particular person, on the phone with another user, had a certain application open on the user's desktop, and was browsing a particular Web site. In one state the interface can show each of these different types or avenues of data along a different axis or plane, but through a rotation or other manipulation of the interface the interface can display information across all these dimensions on a single dimension axis or other such representation for a selected time.

Another advantage of an interface such as that illustrated with respect to FIG. 4(b) is that a user can zoom in and out to obtain any level of granularity of information as desired, corresponding to any appropriate range of time. Further, when multiple dimensions are displayed as elongated parallel axes, for example, the user can scroll or “shift” back and forth in time to view information over different time periods. In some embodiments, a user can scroll forward in time to obtain information for scheduled or predicted events. For example, a user can obtain information about people who will be attending upcoming meetings, locations where the user is scheduled to be, etc.

A user also can manipulate various aspects of such an interface. For example, instead of sorting each dimension along a dimension such as time, a user can have the option to sort according to a particular axis or dimension as discussed elsewhere herein. Further, the user can change the selection of dimensions that are displayed. In some embodiments, the user might select specific dimensions to display, such as by adding or removing dimensions. In other embodiments, a user might select a particular “context” which will determine the dimensions that are displayed. For example, a user might select a “location” context that might include information about places that were visited and people with whom the user met. Another context might be a “calls” context that includes information such as contacts, address book information, and calendar information. Another view might correspond to a view for a particular application, that might include data created by, or used with, that application. Instead of opening an application to obtain specific sets of data, a user can open a common interface and select the “context” of the data to obtain the desired information. An advantage to such an approach is that other dimensions of data are still associated with the data for a current context, such that if the user wants to view information from other dimensions, the user simply changes the context or otherwise adjusts the display. In conventional approaches, the user would have to open another application and import the data into a common application in order to compare specific information or perform other tasks involving data for different applications. Using an interface in accordance with various embodiments enables a user to define, select, configure, change, update, or otherwise modify any selections of data for any number of dimensions, as well as the ways in which that data is displayed, viewed, or otherwise utilized.

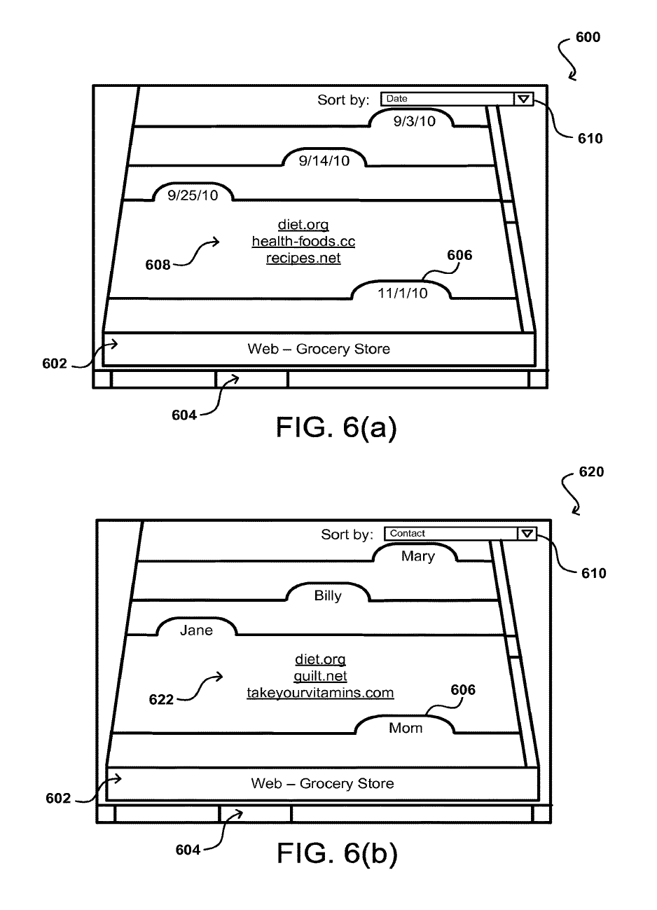

When a user navigates to a dimension of interest, the user can select to view more information about that dimension. This can be accomplished by, for example, selecting a specific dimension or centering a given dimension and then performing a “zoom” or similar action on the device. As a result of such an action, information for a particular dimension can be displayed in greater detail. For example, FIG. 5(a) illustrates, in the interface display 500, information for the “Web” dimension. Such a dimension can enable a user to quickly locate information such as a list of Web sites that the user visited, places where the user purchased specific items, places where the user submitted comments or reviews, or any other address or location where the user performed a recordable action.

In FIG. 5(a), the information is sorted and displayed using a conventional alphabetical sorting approach. Thus, the user can scroll along the dimension using a scroll element 510 or similar approach to move quickly to the letter of interest. By selecting on a tab 506 or other icon representing a specific letter, for example, the user can obtain a list of uniform resource locators (URLs), icons, or other such addresses or information corresponding to that letter.

For a user who has visited many Web sites, or a user who might not remember the name of the site or the specific URL, however, such an approach might not be particularly helpful. Consider an example where the user does not remember the URL, and thus cannot quickly lookup the URL alphabetically, but remembers accessing that URL while at work the previous day. FIG. 5(b) illustrates an example interface wherein the user is able to adjust a sorting of the Web data according to a specific dimension, here using a sort element 512 (e.g., a drop-down menu) to sort the Web data by location. As can be seen, the tabs 552 (or other icons) no longer correspond to letters, but instead correspond to locations where the user has accessed Web information. In this particular example, the locations shown include the users' place of work, the user's home, a grocery store, and in the user's car. Various other locations might be represented but are not viewable without scrolling, zooming, or otherwise adjusting the display. In this example, the user has selected the “work” tab 552 and is able to view a list of URLs 554 that the user accessed at work. This list also can be scrollable or otherwise adjustable, such as to view URLs by specific date or another such dimension. In this example, the user is able to obtain a preview window 558 for a URL by moving a mouse pointer 556 over a link, or otherwise interacting with a listed link. In some cases, the user can then quickly locate the link of interest and select the appropriate link, preview window, or other such element to navigate to the Web page of interest. If the user cannot find the information of interest, the user can use the sort option 512 to sort by another dimension or can use the scroll option 504 to attempt to search on another dimension. Various other options can be used as well within the scope of the various embodiments.

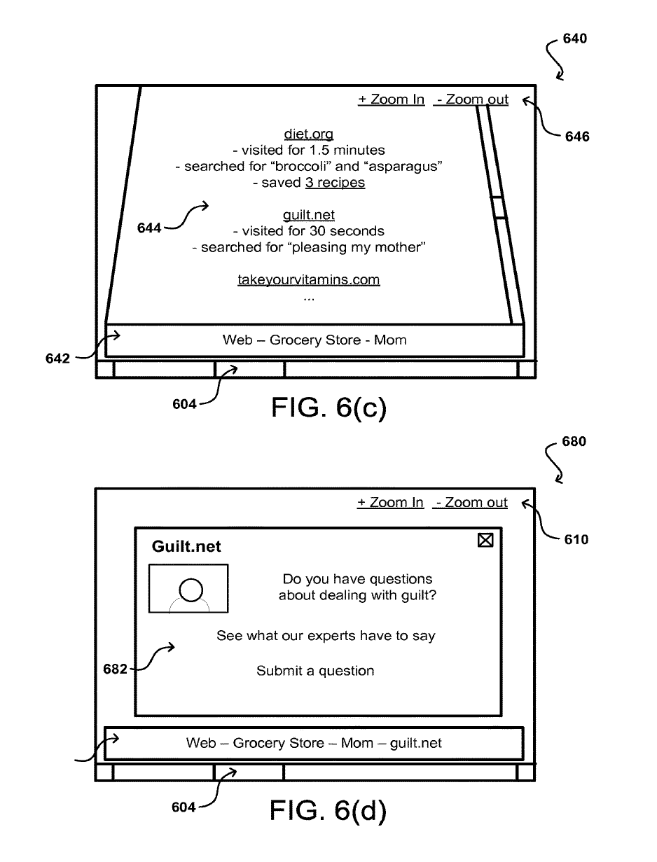

In some embodiments, the user might want to view information for a combination of those dimensions. For example, in FIG. 5(b) there might be a significant amount of Web data that is associated with the grocery store which the user might want to be able to view according to another dimension. In such a case, the user can select to add or join the additional dimension to the existing dimension. For example, the user might click on the appropriate tab for the grocery store in FIG. 5(b), or might center the tab for the dimension and then adjust the position or orientation of the device, such as to switch or rotate the “view” to now include the “grocery store” portion of the Web data. The portion then can similarly be expanded and displayed, such as is illustrated in the example interface display 600 of FIG. 6(a). In this example, it can be seen that the data represents the intersection of multiple dimensions 602, here the Web and Grocery Store location data. By using the scroll bar 604 or a similar approach at this level, the user could move to other combinations with the Web data, such as Web with contacts or Web with calls or social data.

As can be seen, the instances where the user has Web data corresponding to the Grocery Store can be filtered using another filter option 610 to separate specific instances, here illustrating which URLs 608 were accessed by the user on the device at the grocery store on each of a set of different dates, each corresponding to a specific date tab 606 or icon. As in the previous examples, however, the user can also use the sort option 610 to sort the data by another dimension. As illustrated in the example interface display 620 of FIG. 6(b), the user can sort by a dimension such as “contact.” Thus, the user can select a tab 606 for a contact such as “mom” to view those URLs 622 that the user viewed while at the grocery store while the user was with, or at least in proximity to, his mother. Such an approach can quickly help a user to find a URL that the user's mother told him or her about while they were at the grocery store, which would require a significant amount of effort to locate using conventional approaches.

At the zoom level of the display in FIG. 6(b), the user might only be able to view a limited amount of information, such as a list of URLs. In at least some embodiments, the user can have the option of zooming in to obtain more detailed information, as well as zooming out to obtain less detailed information or go back to a previous dimension or combination or dimensions, etc. This can be accomplished through one or more selectable elements 646, or by performing a motion of the device as discussed elsewhere herein. In FIG. 6(c), the user has zoomed in on the Mom tab for the Web-Grocery store data selected in FIG. 6(b), which can result in a new, more detailed selection of information 644 that is shown to correspond to a new combination of dimensions 642. At this level, the user can obtain additional information about each data point, such as how long the user visited each URL, actions the user took with respect to the URLs, etc. In some instances, information such as the length of interaction of a user with a URL can also (or alternatively) be provided as a separate dimension, as a user can search for useful sites based upon the amount of time the user spent interacting with each site, page, etc. In some cases, the user can select a data point or zoom even further in to get information about a specific URL, or even to navigate to that site, as illustrated in the example interface display 680 of FIG. 6(d), which illustrates a display 682 of the selected Web site. Such an approach can be used to navigate to a specific Web site from an application other than a Web browser, using dimensions that traditionally are not able to be used to locate a Web site but that can correspond more closely with how a user stores and relates information.

Another advantage to such an approach is that a user can take multiple paths to get to the data of interest. For example, in FIGS. 6(a)-6(d) a user found a certain Web site by starting with the Web dimension and then focusing on the location where the site was viewed and then who the user was with at the time. The user could have, instead, started with any other associated dimension, such as the person the user was with when viewing the site, or the location, time of day, device used to view the site, etc. A user thus can utilize any appropriate number and/or selection of dimensions of data to locate the information of interest, which enables each user to utilize and approach that matches most closely with that user's way of processing, storing, and/or retrieving information.

It should be understood that data for any appropriate dimensions can be captured, associated, stored, displayed, processed, or otherwise handled within the scope of the various embodiments. The data collected can be determined based on any of a number of factors as discussed elsewhere herein. For example, a portable media player might not have position-determining capabilities, or a desktop computer might not have any significant benefit to capturing position information over time. In other cases, a user might not want that user's position tracked over time, etc. In these or other cases, there can be different sets of information captured that can still monitor the behavior and/or actions of a user, group or users, entity, etc.

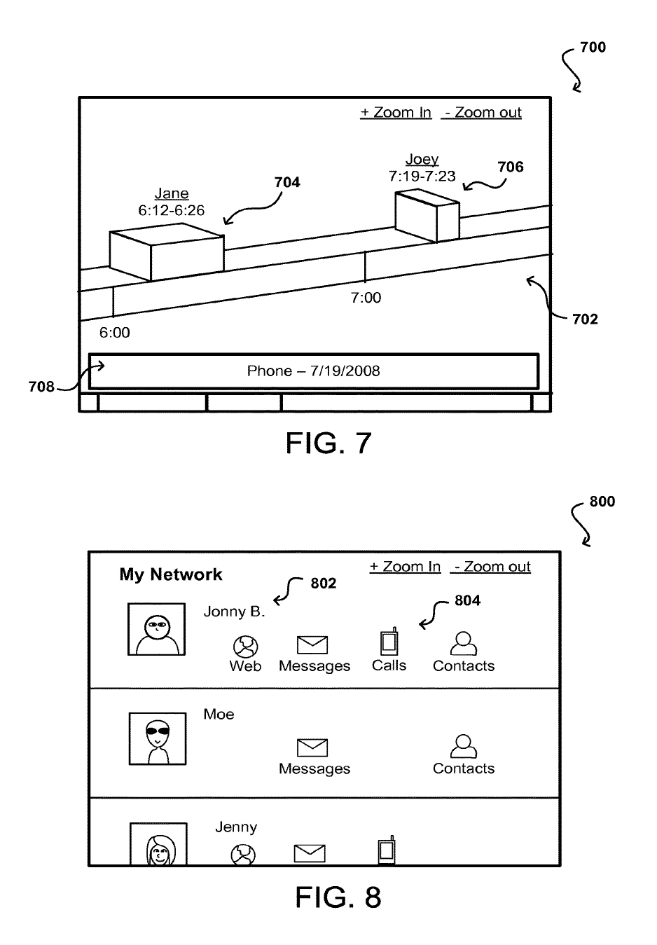

For example, FIG. 7 illustrates an example interface display 700 wherein a user has navigated to a “phone” dimension 708 and also the records for a specific date, here Jul. 19, 2008. This display can be part of the interface illustrated with respect to the prior examples, or can be part of a separate interface for a separate device. In this example, the interface is displaying the call information for the day in question 702 along an axis representing the time period for the day in focus. In this example, the user can navigate (e.g., scroll or zoom) to specific periods of time, here from just before 6:00 to around 8:00. In this example, the calls are represented as blocks of time along the time axis, here being raised blocks but it should be understood that these blocks could be positioned inline with the axis, etc. In this example, the user can see that there were two calls during the period being viewed, one conversation 704 with Jane that lasted from 6:12 until 6:26, and another conversation 706 with Joey that lasted from 7:19 until 7:23. Such an approach enables a user to easily determine the times when the user was on the phone, as well as the duration of each call and details about the call. As with other examples, the user can select or zoom in on these blocks to get a more detailed view and/or more information, such as the information illustrated for the call in FIG. 3(b). It should be understood that the user, if the information is available, can also change the type of display to move to a view such as that in FIG. 3(b). For example, if the user locates a call using the interface of FIG. 7 and wants to determine where the user was when the user received the call, the user can select that call and switch to a map view, which can present the user with the location of the call, etc. Various other views can be used as well to obtain different types of information. Further, the interface can be zoomed in to get information such as detailed transcriptions or zoomed out to view other dates and/or times, etc., as with other examples discussed herein. If information in the call is of interest, the user can cause the device to perform a specific action, such as to add an action to a “to do” list or add a meeting to a calendar. If the user had activated an “action” or similar mode during the call, the device could potentially have analyzed the content of the call and automatically performed that action. In still other embodiments, the device might be configured and/or authorized to actively listen to conversations, parse messages, etc., in order to proactively handle certain tasks or perform certain actions.

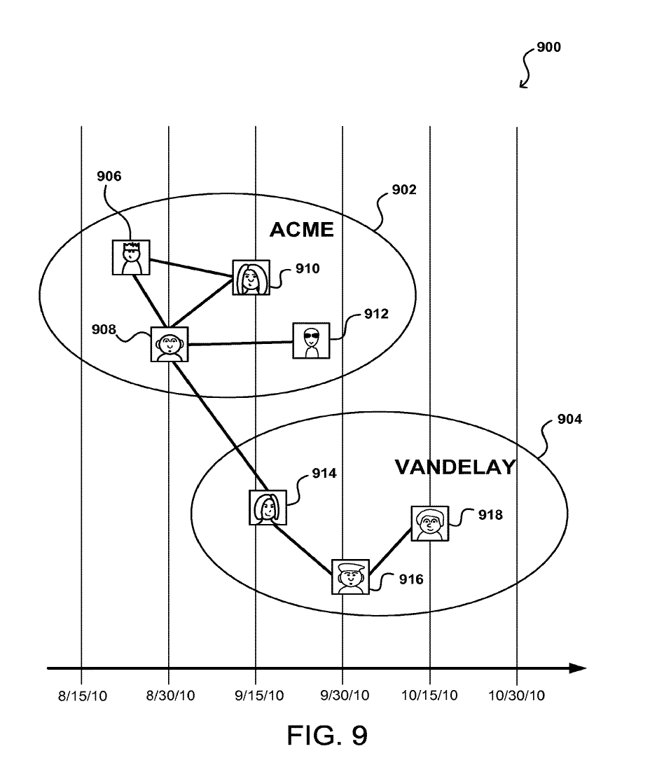

In addition to map and axis or plane-based interfaces, various other interfaces can be displayed that enable users to location and/or view information in ways that are intuitive to the user. For example, FIG. 8 illustrates an example interface display 800 wherein a user is able to view information starting with a social-networking dimension and layout. In this example, a user might be able to scroll, zoom, or otherwise navigate to a set or type of connections. The connections could be sorted using any appropriate sorting scheme, such as to sort alphabetically, sort by recent activity, sort by personal or business connection, etc. A user can have the ability to zoom in to view information for a single connection 802, or group of adjacent connections. In some embodiments, the user can also apply one or more filters to attempt to display only a certain type of connection.

Along with the information for each connection 802 can be icons 804 or other selectable elements that indicate types of information along other dimensions that are available for that connection. For example, it can be seen that Jonny B. and Jenny have had telephone calls with the user, but Moe has not. Further, Moe has not shared a Web site with the user. Such information can be beneficial if a user is attempting to locate a site that one of the user's friends or co-workers shared, but the user cannot remember the exact person who shared the site. Further, the icons enable a user to quickly add a dimension to the display. For example, if the user wants to view contacts that the user shares with Jonny B, the user can select the appropriate Contacts icon associated with Jonny B and have the set of shared contacts displayed. Various other approaches and elements can be includes as well as would be apparent to one of ordinary skill in the art in light of the teachings and suggestions contained herein.

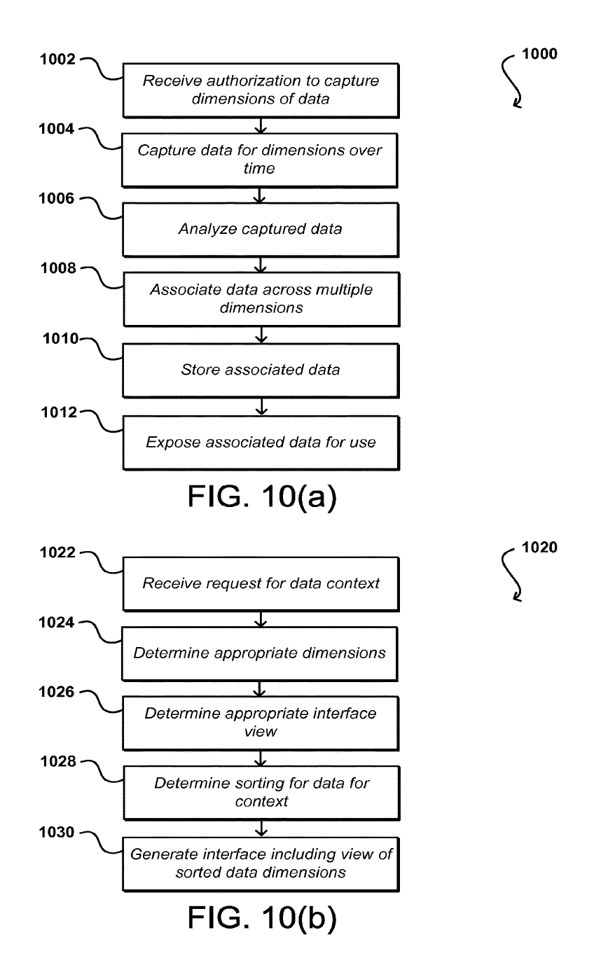

Other interface approaches can be utilized with social data as well. For example, FIG. 9 illustrates an example social graph 900 wherein social network-based navigation is enabled via clustering and sorting connections. Although a two-dimensional graph is illustrated, it should be understood that three-dimensional and/or animated approaches can be used as well within the scope of the various embodiments. Each icon (e.g., icon 906) can represent a contact, with the links between contacts corresponding to connections. The links can be used to determine the social proximity of various persons to connections in a user's social network. In this example, contacts are grouped by company, with the ACME employees being clustered in a first group 902, and the Vandelay employees being clustered in a second group 904. Even though persons might be contained within a common group, those persons might not all be connected to each other, at least according to the connection data. For example, contacts 906, 908, and 910 in the ACME group are all connected with each other, but contact 912 is only connected to contact 908. The link between contact 908 and contact 914 also connects the ACME group 902 with the Vandelay group 904. One thus could determine the social proximity of contact 918 to contact 908 by the connections through contacts 914 and 916.

Further, the contacts can be sorted using at least one appropriate dimension. In this example, the contacts are displayed left to right by the date in which an action occurred, such as contact with a common user, data of most recent phone call, attendance in a common meeting, etc. The interface can attempt to maintain clustering, while positioning the icons for each contact along the axis such that the user can still search for information according to another dimension. For example, from this graph the user might be able to determine that contact 918 was the last contact at Vandelay with which the user spoke, and contact 912 was the last contact at ACME with which the user spoke. Similarly, the user can determine how long it has been since the user spoke with each contact, for example, in case the user should contact one or more of them, etc. Various other uses and sort dimensions can be used as well as should be apparent in light of the teachings and suggestions contained herein.

As can be seen, information from various dimensions can be combined and accessed in ways that are intuitive to the user, and that enable the user to locate information following paths that were not previously available via conventional interfaces. Devices can provide different approaches to enable different users to find the same information along different paths. For example, certain users might associate information with places, while other users might associate information with people, activities, semantics, time, dominant color, decibel level or pitch, or other such information. The ability to change the type of interface, and locate information by combining information for various dimensions, enables users to obtain a customized information location system without any customization or configuration process, using approaches that are intuitive to the user.

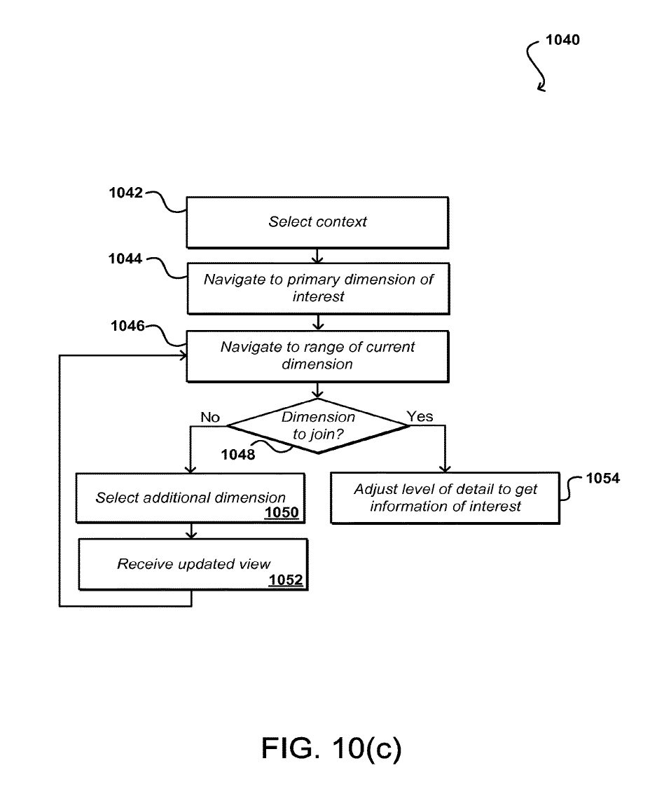

FIGS. 10(a), (b), and (c) illustrate portions of an example process that can be used to capture, associate, and utilize data across multiple dimensions in accordance with one embodiment. It should be understood that there can be additional, fewer, or alternative steps performed in similar or alternative orders, or in parallel, within the scope of the various embodiments unless otherwise stated. In a first portion 1000 of the example process as illustrated in FIG. 10(a), a user authorizes a device to capture various dimensions of data 1002. In some embodiments a user might also have to authorize various dimensions to be associated with other dimensions and/or utilized with certain applications. In other embodiments, a device might be able to capture information for certain dimensions in order to associate data, but might not be allowed to store and/or expose that data. Various other options are possible as well. For example, a user might specify certain types of data within a dimension not to be stored, exposed, etc.

Once authorized, a device can capture information for all authorized dimensions over time 1004. In some embodiments, a device can monitor the state of various dimensions and record data as appropriate. For example, if a user leaves the device on a table for an extended period of time, the device might store the position when the device is first set down, but might not store or capture position data again until the device is moved, as may be detected by an accelerometer, GPS device, etc. As another example, a device might only record data for messages as they arrive or are transmitted, etc. In other embodiments, a device might store data points periodically, such as updating the position or location of the device every second, ten seconds, thirty seconds, etc.

The captured data can be analyzed or processed 1006 and data across various dimensions can be associated 1008, such as by tagging each data point, storing appropriate meta data, or otherwise providing a mapping or correlation between data points. In some embodiments, a dimension such as time can be used to correlate data across different dimensions. In other embodiments, a random, generated, or encoded alphanumeric identifier can be used to tag associated data points across multiple dimensions. In still other embodiments, mappings can be maintained or table entries associated in order to maintain data associations across the appropriate dimensions. For example, data might be associated by dimensions such as time, location, person, temperature, spend of movement, song that was playing, food that was eaten, heart rate, fragrance, emotion gleaned from user's face or tone of voice, an application the user was using, the battery level of device, an amount of ambient sound or light, purchase history, language spoken, etc. In some embodiments, a system can generate a broadcast API call, with or without “dimensional filters,” when an application generates an “interesting” data point (e.g., the times when phone call started and ended, web site was visited, etc.). Other services within (or external to) the device can listen for this broadcast and add their own context data to the event (i.e., a GPS service can add location, a time service can add time, etc.). The data can still be stored in separate tables with associative keys, or in one tagged block, for example, but such an approach allows future services to add their own dimension to data generation events. Events of interest are thus tagged with data that can be used later to associate across those dimensions with tagging services.

The associated data can be stored to an appropriate data store 1010, such as may be maintained on the device itself or stored remotely or across a network. In some embodiments, data from multiple devices can be aggregated and/or associated using an association approach similar to those discussed above. Once the data is stored, that data can be exposed for use by any number of users, applications, modules, or other such entities or components 1012. In some cases, the device might also store rules dictating which entities or components can utilize certain types or dimensions of data and/or how that data can be utilized.

FIG. 10(b) illustrates an example portion 1020 of the process wherein the stored data from FIG. 10(a) can be used to generate a multi-dimensional interface in accordance with one embodiment. In this example, a device can receive a request from a user, application, or other such entity or component to provide a view of the data corresponding to a specific context 1022. As discussed elsewhere herein, a “context” can correspond to any appropriate collection or grouping of dimensions, such as may be appropriate for a navigation context, shopping context, word processing context, messaging context, etc. Based at least in part upon the specified context, a device can determine the appropriate dimensions to be displayed 1024 as well as the appropriate type of interface view 1026. For example, a navigation context might by default (or as otherwise specified) utilize a “map” view as an initial state, while a social networking view might utilize a connection-based view. Similarly, the default (or otherwise specified) set of dimensions for each context can vary, and in some embodiments might come from multiple data stores or other such sources. The device also can determine an appropriate dimension (or other approach) to use for sorting the data 1028. For example, the default (or otherwise specified) sort dimension for a call log view might be time related, starting with the most recent calls, while a contacts view might be sorted alphabetically or by type of contact. If the view displays information for different offices of a company, those offices can be sorted by age, size, number of employees, amount of revenue, or any other such dimension. Once the appropriate settings and values are determined, an interface can be generated to be displayed on the device that includes the selected dimensions in the appropriate view, sorted using the appropriate dimension 1030.

FIG. 10(c) illustrates a third portion 1040 of the example process that enables a user (or application, etc.) to manipulate the data and dimensions displayed, in order to perform such tasks as to locate files or information, or to determine various data associations, etc. For simplicity of understanding the process will be described from the point of view of a user working with the interface and submitting instructions, but it should be understood that a corresponding process occurs from the point of view of the processing device performing those actions and receiving those instructions. In this example, a user selects a context in which to view data 1042. As discussed above, the context can determine aspects such as the selection of dimensions and type of view to be displayed. Data for multiple dimensions then can be displayed to the user, according to the selected context. The user can navigate to the initial dimension of interest (if not already selected) 1044, and can navigate (e.g., scroll or zoom) to the range of the dimension that is of interest 1046. If the user has another dimension to add or combine in order to adjust the view 1048, the user can select the additional dimension 1050, such as by selecting an icon, rotating the device, or performing another such action as discussed elsewhere herein. The user then can receive an updated view 1052 corresponding to the combined dimensions. The user can continue combining dimensions (or removing dimension combinations) until the user is at the appropriate type of information. At that point, the user can adjust the level of detail as appropriate to get to the information of interest 1054. The adjustment can include any number of actions, such as zooming or scrolling, selecting icons or specific information, etc. As should be understood, various other approaches can be used as well that take advantage of associated data across multiple dimensions.

In order to further enhance the intuitive nature of such an interface, an application associated with the interface can accept motion commands from a user as input to the interface. For example, if a user wants to rotate an axis in a three-dimensional representation then the user can perform an action such as to rotate or tilt the device. If the device has a camera with image recognition, the user can perform a motion such as to swipe a hand in the intended direction, make an appropriate head motion, perform a specified action, etc. Various other types of input can be used as well, such as voice or image input.

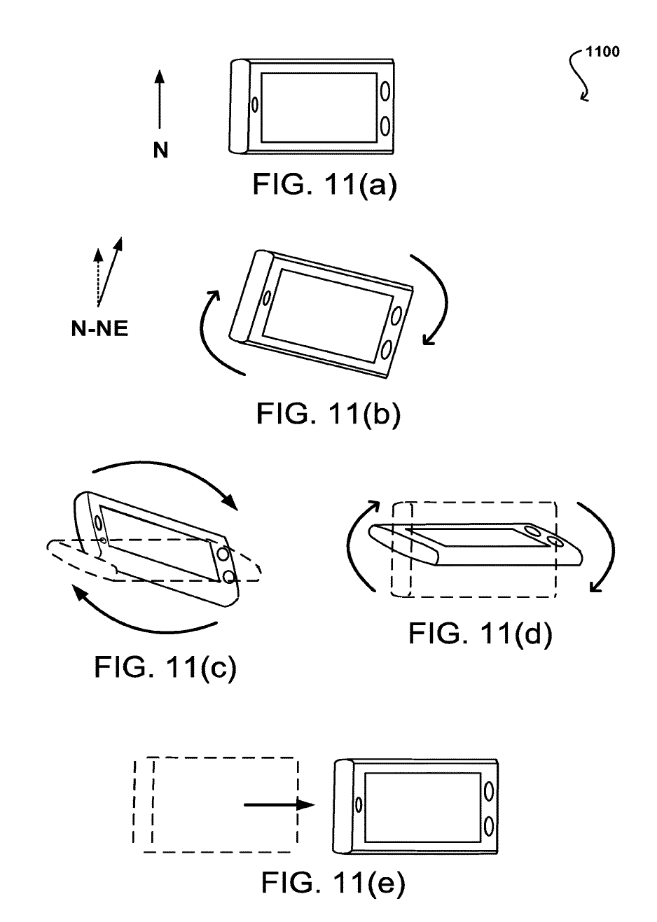

As discussed above, a portable device can include at least one orientation and/or location determining element, such as an accelerometer, electronic compass, or gyroscope. FIGS. 11(a)-11(e) illustrate example types of information that can be obtained using location and/or orientation determining elements of an example device 1100 in accordance with various embodiments. As discussed, such information can be used to provide input to a portable device, which can be used to adjust various aspects of an interface display. For example, FIG. 11(a) illustrates that the device is facing substantially north (according to a selected or defined axis of the device), while FIG. 11(b) illustrates that the device has been adjusted in direction such that the device is now facing in a north-northeast direction. The change in direction, as well as the number of degrees or other measurement of the change, can be determined using an element such as an electronic compass. FIGS. 11(c) and 11(d) illustrate changes in orientation (e.g., tilted to the side and back, respectively) that do not change the direction and thus would might be picked up as a direction change by a compass. Such changes in orientation can be picked up by an orientation determining element such as an accelerometer or gyroscope. FIG. 11(e) illustrates a change in the position of the device. While such motion can be picked up by an element such as an accelerometer, an element such as a GPS device can give more accurate and/or precise location information for a current position of the device in at least some situations. Various other types of elements can be used as well to obtain any of these and other changes in orientation and/or location.

The ability to view information across multiple dimensions and prevent the data from being constrained to data silos can be beneficial for other purposes as well. For example, various applications can take advantage of other types or dimensions of data that are associated with application data, but that were not previously available in an associated and easily accessible way. For example, a navigation application might not previously have had access to calendar and contact data. If a navigation application with visibility across multiple dimensions of data detects a traffic accident that will delay a user, the application can check calendar information to see if the user is likely to be late for a meeting, and if so can take action such as to check the contact information for the persons scheduled to be at the meeting and notify those persons that the user will likely be late. In some conventional approaches, it is not possible for the GPS data, traffic data, and mapping data to all be used together effectively because that data was associated with different applications. Such an approach can work across many traditional data boundaries, where allowed by the user, which can enable expanded functionality for many different applications. In addition to making the data available, the data can be tagged, mapped, or otherwise associated such that applications know how to utilize and/or correlate the data from different dimensions.

Further, a user might no longer open “applications” in a traditional sense, but instead might open up a “context.” For example, instead of opening a Web browser the user might select a Web “view” in order to navigate to a site of interest, which might be displayed in a different view of the interface. A user might view a calendar in a similar fashion, without ever having to open or utilize a dedicated calendar application. Applications can be selected that conform to a certain tagging standard, for example, that enables data captured by that application to be associated with other dimensions of data. In other embodiments, the operating system of a device might be configured to capture and associate data across all defined dimensions, for example, and applications are configured to utilize that data. In such embodiments, applications would not store their own data, but would work with the operating system to cause certain actions to be performed.

In some embodiments, the device capturing information might not determine and/or maintain all the appropriate associations, and/or may enable third party applications or other such sources to generate relevant associations. For example, a device can provide a broadcast application programming interface (API) or other such interface that third parties can use to obtain user data. For example, a variety of applications can subscribe to receive information about certain events, such as occurrences of certain types of data for certain dimensions. When an event occurs, the device can broadcast the event and subscribing services can tag the information using their own context in order to establish associations that are relevant for that application. For example, a navigation application may not care about social networking information, and a calendaring application might not care about messages received, etc. The applications can obtain information for certain types of events and determine whether to associate and store that data for a particular user, device, entity, etc.

Such an approach can be used to provide a variety of services for the user. For example, the device can suggest the best route to take to work or return home based on time of day and day of week. The device can ask to reschedule meetings where the attendees are determined to be unable to make the meeting on time due to their current location. If users are determined to be near each other, the device can provide a notification and ask if the user would like to meet up with the other user. If there are places that a user needs to go that are determined to be along the inferred route, the device can prompt the user to stop at that location if the user will have enough time based on current conditions. Various other services can be provided as well.

In addition to applications, other entities or modules such as Web sites or electronic marketplaces can be configured or programmed to utilize such information as well. In some embodiments, an electronic marketplace might not display information through a conventional Web page in a browser, but might provide information to a device that can be displayed along one or more dimensions of a multi-dimensional interface and can be sorted and modified just as any data stored on the device. For example, a shopping view might show dimensions such as past purchases, browse history, reviews, wish list items, etc. A user can select such a view and navigate to content of interest using approaches discussed and suggested herein. Further, since the data can be associated with other data dimensions, the user can obtain information that would not previously have been readily determinable. For example, if a product on the marketplace was reviewed by a reviewer that the user recognizes, but cannot remember where the user met that reviewer, the user can change the view to combine contacts, location, or other such dimensions with the shopping dimension to locate the information.

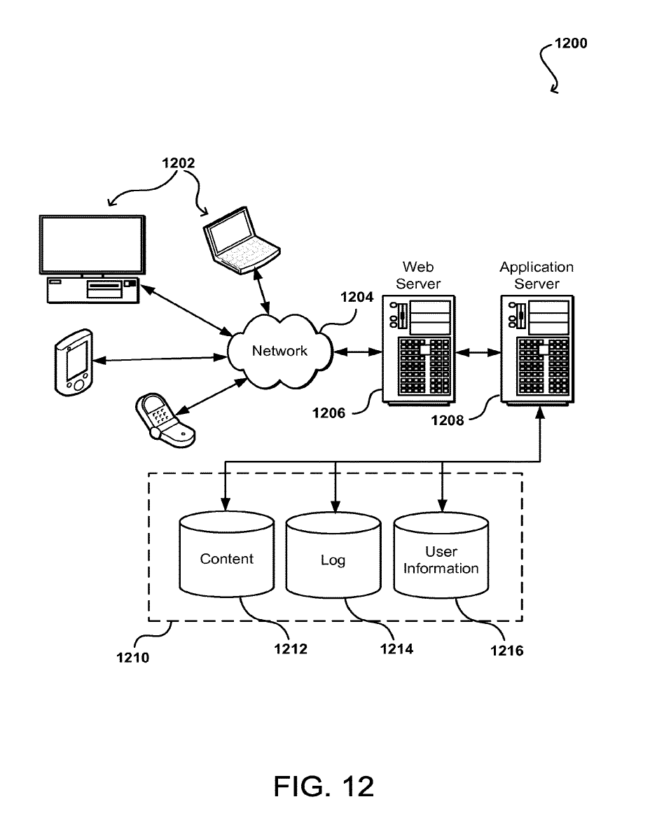

As discussed, different approaches can be implemented in various environments in accordance with the described embodiments. For example, FIG. 12 illustrates an example of an environment 1200 for implementing aspects in accordance with various embodiments. As will be appreciated, although a Web-based environment is used for purposes of explanation, different environments may be used, as appropriate, to implement various embodiments. The system includes an electronic client device 1202, which can include any appropriate device operable to send and receive requests, messages or information over an appropriate network 1204 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 1206 for receiving requests and serving content in response thereto, although for other networks an alternative device serving a similar purpose could be used, as would be apparent to one of ordinary skill in the art.

The illustrative environment includes at least one application server 1208 and a data store 1210. It should be understood that there can be several application servers, layers or other elements, processes or components, which may be chained or otherwise configured, which can interact to perform tasks such as obtaining data from an appropriate data store. As used herein the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XML or another appropriate structured language in this example. The handling of all requests and responses, as well as the delivery of content between the client device 1202 and the application server 1208, can be handled by the Web server 1206. It should be understood that the Web and application servers are not required and are merely example components, as structured code discussed herein can be executed on any appropriate device or host machine as discussed elsewhere herein.

The data store 1210 can include several separate data tables, databases or other data storage mechanisms and media for storing data relating to a particular aspect. For example, the data store illustrated includes mechanisms for storing production data 1212 and user information 1216, which can be used to serve content for the production side. The data store also is shown to include a mechanism for storing log or session data 1214. It should be understood that there can be many other aspects that may need to be stored in the data store, such as page image information and access rights information, which can be stored in any of the above listed mechanisms as appropriate or in additional mechanisms in the data store 1210. The data store 1210 is operable, through logic associated therewith, to receive instructions from the application server 1208 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 1202. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 12. Thus, the depiction of the system 1200 in FIG. 12 should be taken as being illustrative in nature and not limiting to the scope of the disclosure.

As discussed above, the various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. (canceled)

2. A computer-implemented method, comprising:
generating first application usage data representing application usage of a first application of a computing device;
generating second application usage data representing application usage of a second application of the computing device;
determining, from the first application usage data, a first time of a first interaction with the first application within a first time range;
determining, from the first application usage data, a first duration of the first interaction within the first time range;
determining, from the second application usage data, a second time of a second interaction with the second application within the first time range;
determining, from the second application usage data, a second duration of the second interaction within the first time range; and
displaying, on a display screen of the computing device, first content including representations of at least the first time, the second time, the first duration, and the second duration.

3. The computer-implemented method of claim 2, further comprising:
receiving input corresponding to scrolling of a time axis associated with the first content;
determining, from the first application usage data, a third time of a third interaction with the first application within a second time range associated with a same unit of time as the first time range;
determining, from the first application usage data, a third duration of the third interaction within the second time range;
determining, from the second application usage data, a fourth time of a fourth interaction with the second application within the second time range;
determining, from the second application usage data, a fourth duration of the fourth interaction within the second time range; and
displaying, on the display screen, second content including representations of at least the third time, the third duration, the fourth time, and the fourth duration.

4. The computer-implemented method of claim 2, further comprising:
generating third application usage data representing application usage of a third application of the computing device;
receiving input corresponding to scrolling of an application axis associated with the first content;
determining, from the third application usage data, a third time of a third interaction with the third application within the first time range;
determining, from the third application usage data, a third duration of the third interaction within the first time range; and
displaying, on the display screen, second content including representations of at least the third time and the third duration.

5. The computer-implemented method of claim 2, further comprising:
receiving input associated with displaying content associated with a unit of time that represents a shorter length of time than a previous unit of time associated with the first content;
determining, from the first application usage data, a third time of a third interaction with the first application within a second time range associated with the unit of time;
determining, from the first application usage data, a third duration of the third interaction within the second time range; and
displaying, on the display screen, second content including representations of at least the third time and the third duration.

6. The computer-implemented method of claim 5, further comprising:
determining one or more content items interacted with by the first application at the third time or within the third duration,
wherein the second content further includes representations of the one or more content items.

7. The computer-implemented method of claim 5, wherein the input is further associated with a selection of the first application.

8. The computer-implemented method of claim 7, wherein the input is a single gesture.

9. The computer-implemented method of claim 2, further comprising:
receiving input associated with displaying content associated with a unit of time that represents a greater length of time than a previous unit of time associated with the first content;
determining, from the first application usage data, a third time of a third interaction with the first application within a second time range that corresponds to the unit of time;
determining, from the first application usage data, a third duration of the third interaction within the second time range;
determining, from the second application usage data, a fourth time of a fourth interaction with the second application within the second time range;
determining, from the second application usage data, a fourth duration of the fourth interaction within the second time range; and
displaying, on the display screen, second content including representations of at least the third time, the third duration, the fourth time, and the fourth duration.

10. The computer-implemented method of claim 9, further comprising:
generating third application usage data representing application usage of a third application of the computing device;
determining, from the third application usage data, a fifth time of a fifth interaction with the third application within the second time range; and
determining, from the third application usage data, a fifth duration of the fifth interaction within the second time range,
wherein the second content further includes representations of at least the fifth time and the fifth duration.

11. The computer-implemented method of claim 2, further comprising:
receiving input associated with a selection of a type of application usage that is different from a previous type of application usage associated with the first content;
determining, from the first application usage data, a first amount of the type of application usage for at least one of the first time or the first duration;
determining, from the second application usage data, a second amount of the type of application usage for at least one of the second time or the second duration; and
displaying, on the display screen, second content including representations of at least the first amount and the second amount.

12. The computer-implemented method of claim 11, wherein the type of application usage is selected from a group comprising processing, memory, storage, network, or power usage by an application.

13. The computer-implemented method of claim 11, wherein the first amount is one of an absolute amount or a relative amount.

14. A computing device, comprising:
one or more processors;
a display screen; and
memory including instructions that, upon being executed by the one or more processors, cause the computing device to:
generate first application usage data representing application usage of a first application of the computing device;
generate second application usage data representing application usage of a second application of the computing device;
determine, from the first application usage data, a first time of a first interaction with the first application within a first time range;
determine, from the first application usage data, a first duration of the first interaction within the first time range;
determine, from the second application usage data, a second time of a second interaction with the second application within the first time range;
determine, from the second application usage data, a second duration of the second interaction within the first time range; and
display, on the display screen, first content including representations of at least the first time, the first duration, the second time, and the second duration.

15. The computing device of claim 14, wherein the instructions upon being executed further cause the computing device to:
receive input corresponding to a selection of a sorting criterion from a group comprising an amount of processing, memory, storage, network, or power usage by an application;
determine an order of applications of the computing device that corresponds to the sorting criterion;
generate third application usage data representing application usage of a first ordered application of the order;
generate fourth application usage data representing application usage of a second ordered application of the computing device;
determine, from the third application usage data, a third time of a third interaction with the first ordered application within the first time range;
determine, from the third application usage data, a third duration of the third interaction within the first time range;
determine, from the fourth application usage data, a fourth time of a fourth interaction with the second ordered application within the first time range;
determine, from the fourth application usage data, a fourth duration of the fourth interaction within the first time range; and
display, on the display screen, second content including representations of at least the third time, the third duration, the fourth time, and the fourth duration.

16. The computing device of claim 14, wherein the instructions upon being executed further cause the computing device to:
generate third application usage data representing application usage of a third application of the computing device;
receive input corresponding to a rotation of the computing device that shortens a time axis associated with the first content and lengthens an application axis associated with the first content;
determine, from the first application usage data, a third time of a third interaction with the first application within a second time range that is shorter in length than the first time range;
determine, from the second application usage data, a third duration of the third interaction within the second time range;
determine, from the second application usage data, a fourth time of a fourth interaction with the second application within the second time range;
determine, from the second application usage data, a fourth duration of the fourth interaction within the second time range;
determine, from the third application usage data, a fifth time of a fifth interaction with the third application within the second time range; and
determine, from the third application usage data, a fifth duration of the fifth interaction within the second time range; and
display, on the display screen, second content including representations of at least the third time, the third duration, the fourth time, the fourth duration, the fifth time, and the fifth duration.

17. The computing device of claim 14, wherein the instructions upon being executed further cause the computing device to:
receive input corresponding to displaying content associated with a unit of time that represents a shorter length of time than a previous unit of time associated with the first content;
determine, from the first application usage data, a third time of a third interaction with the first application within a second time range associated with the unit of time;
determine, from the first application usage data, a third duration of the third interaction within the second time range;
determine one or more content items interacted with by the first application at the third time or within the third duration; and
display, on the display screen, second content including representations of at least the third time, the third duration, and the one or more content items.

18. A non-transitory computer-readable medium including instructions that, upon being executed by one or more processors of a computing device, cause the computing device to:
generate first application usage data representing application usage of a first application of the computing device;
generate second application usage data representing application usage of a second application of the computing device;
determine, from the first application usage data, a first time of a first interaction with the first application within a first time range;
determine, from the first application usage data, a first duration of the first interaction within the first time range;
determine, from the second application usage data, a second time of a second interaction with the second application within the first time range;
determine, from the second application usage data, a second duration of the second interaction within the first time range; and
display, on a display screen of the computing device, first content including representations of at least the first time, the first duration, the second time, and the second duration.

19. The non-transitory computer-readable medium of claim 18, wherein the instructions upon being executed further cause the computing device to:
determine a chronological order of applications of the computing device that corresponds to respective initial usage of each application within a second time range;
generate third application usage data representing application usage of a first ordered application of the chronological order;
generate fourth application usage data representing application usage of a second ordered application of the chronological order;
determine, from the third application usage data, a third time of a third interaction with the first ordered application within the second time range;
determine, from the third application usage data, a third duration of the third interaction within the second time range;
determine, from the fourth application usage data, a fourth time of a fourth interaction with the second ordered application within the second time range;
determine, from the fourth application usage data, a fourth duration of the fourth interaction within the second time range; and
display, on the display screen, second content including representations of at least the third time, the third duration, the fourth time, and the fourth duration.

20. The non-transitory computer-readable medium of claim 18, wherein the instructions upon being executed further cause the computing device to:
receive input corresponding to a rotation of the computing device that lengthens a time axis associated with the first content and shortens an application axis associated with the first content;
determine, from the first application usage data, a third time of a third interaction with the first application within a second time range that is greater in length than the first time range;
determine, from the first application usage data, a third duration of the third interaction within the second time range; and
display, on the display screen, second content including representations of at least the third time and the third duration.

21. The non-transitory computer-readable medium of claim 18, wherein the instructions upon being executed further cause the computing device to:
send at least a portion of the first application usage data to a server remote from the computing device,
wherein the first application usage data includes one or more of an absolute amount or a relative amount of one or more of processing, memory, storage, network, or power usage by the first application.
